(19) United States
(12) Patent Application Publication
(10) Pub. No.: US 2003/0167208 A1
(43) Pub. Date: Sep. 4, 2003

(54) Web to fax food ordering system

(76) Inventors: Patsy J. La Mastro, Manville, NJ (US); Michael La Mastro, Belle Mead, NJ (US); Peter Scott Sidman, Hamilton, NJ (US)

Correspondence Address: Pat La Mastro, 311 Huff Ave., Manville, NJ, 08835, US

(21) Appl. No.: 09/757,402

(22) Filed: Jan. 9, 2001

(51) Int. Cl. G06F 17/60

(52) U.S. Cl. 705/26

(57) ABSTRACT

The technical nature of this invention would be classified as Internet Technology. This invention will allow restaurants to receive food orders by fax from customers using the World Wide Web. This invention allows the public to search for subscribed restaurants, view menus, place orders online that turn into direct fax food orders to the restaurants. The public does all of this using an interface that is located on the World Wide Web.

### CROSS REFERENCE TO RELATED APPLICATIONS

There are no related applications. There is a related Disclosure Document. The related Disclosure Document No. is 483147

### STATEMENT REGARDING FED SPONSORED R&D

This invention was not made under federally sponsored research and development.

### COMPUTER PROGRAM LISTING APPENDIX

The following Programs were used to create the Web To Fax Food Ordering System:

Internet Anywhere Mail Server—used to receive orders from web server. Runs on Fax Server and Email Server.

GFIFAX—Used to send fax to restaurant. Runs on Fax Server

Windows NT 4.0—OS of Fax Server and Email Server.

Free BSD—OS of Web Server

Apachi Httpd—used to interface program to the world wide web. Runs on Web Server.

SendMail—used to transfer orders to Fax Server. Runs on Web Server.

Food.pl—Our Program, written by the Inventors (Patsy LaMastro and Michael LaMastro) listed in this Patent Application. Generates Web Pages and Processes Orders. Runs on Web Server. A copy of this program is enclosed on CD-Rom. The script on the CD opens in Note Pad.

Arachnophilia—Editor Inventors used to create program Food.pl.

### BACKGROUND OF THE INVENTION

The field endeavor of which this invention pertains to is Internet Technology for Online Food Ordering Services.

### BRIEF SUMMARY OF THE INVENTION

This invention will provide the public with a means of ordering food “on-line” and/or viewing menu's “on-line” from subscribed restaurants. The public can access this tool through a World Wide Web browser. This tool will provide the public with a means of viewing full menu's from different restaurants throughout a desired area. The public can search, choose and place an order on-line and can even have his order delivered (if selected restaurant provides delivery), all with a few clicks of a mouse. In turn the restaurant will receive a Fax Confirmation containing the Customer's Information and Order Information. The customer will receive an email confirmation of his order.

### DETAILED DESCRIPTION OF THE INVENTION

Intro

Somewhere someone gets hungry; let's call this person Joe. Joe is tired of picking up the phone and fighting a few busy signals, only to order the same exact meal he ordered the last time. Or maybe Joe has ordered everything on the menu and wants something new. So now Joe has to search through the yellow pages for a different restaurant and find out what they are serving. Do they even serve lunch? Do they deliver? If not, where are they are located? Or maybe Joe is on business or is new to the area . . .

The Web To Fax Food Ordering System will allow the public to search an area, pick out a restaurant type, have all subscribed restaurants displayed, see if delivery is available, order from a full menu, submit their order, view their total and receive an email confirmation. This tool is accessed through the Internet by pointing your browser to the Web To Fax Food Ordering System and following the on screen instructions. The Web To Fax Food Ordering System will be located on an Internet URL currently www.whats2eatonline.com.

How it works . . .

The Tool:

Web To Fax Food Ordering System

The Components Of The Tool:

Web Server

Web Pages (Stored On Web Server)

Email Server

Fax Server

Flow Path:

Consumer>>Internet>>Web Server >>Email Server>>Fax Server>>Phone Company>>Restaurant's Fax Machine

The consumer must have Internet access. The consumer points his or her browser to the Web To Fax Food Ordering System initially and solely located at www.whats2eatonline.com. (Netscape Navigator and Internet Explorer are the recommended browsers.)

www.whats2eatonline.com is hosted on a Web Server and is registered to the inventors. The inventors along with third parties created the Web Server, for which the site is hosted (see computer program listing for third party software).

He or she then views Web Pages created by the inventors. These pages contain a program, written by the inventors (see computer program listing Food.pl) that allows the consumer to browse for and find the restaurant and meal of their choice.

The consumer will then submit their order through these Web Pages (using the Food.pl program) by filling in a form and hitting a submit button. The Web Server (using the Food.pl program) then converts the orders into an email format with the restaurant's fax number as a header in the “To” feild.

The email-formatted order is then sent to and collected by an Email Server. Once the email is successfully received from the Email Server (from the Web Server), the Web Server will display a confirmation on the Consumer's computer. This conformation will provide the Consumer with an order number. The inventors using third party hardware and software created the Email Server (see computer program listing for third party software). The Email Server's main focus is to act as a holding place for orders.

The Email Server then sends the email-formatted order to a Fax Server where it is sorted. The Fax Server then determines destination by looking at the Header of the email (The restaurants fax number). The Fax Server uses this information to fax the email-formatted order to the restaurant via the phone company. The inventors using third party hardware and software created this Fax Server.

Restaurant receives a fax containing customer information and order information. Restaurant must provide own fax machine and dedicated fax line.

If for any reason the fax order can not be transmitted to the to the restaurant, an email will be sent to the consumer, from the Fax Server, letting him know that the order could not be transmitted and why. The email will then instruct the customer to either call in or manually fax in his order.

We claim:

1. Web Interface to Fax Food Ordering, through the World Wide Web.
